(19) United States
(12) Patent Application Publication
(10) Pub. No.: US 2012/0174163 A1
(43) Pub. Date: Jul. 5, 2012

(54) Tuner Control for Streaming Live Television

(75) Inventors: Praveen N. Moorthy, San Diego, CA (US); Kuang M. Chen, San Diego, CA (US); Paul Moroney, La Jolla, CA (US)

(73) Assignee: GENERAL INSTRUMENT CORPORATION, Horsham, PA (US)

(21) Appl. No.: 13/344,590

(22) Filed: Jan. 5, 2012

Related U.S. Application Data
(60) Provisional application No. 61/429,914, filed on Jan. 5, 2011.

(51) Int. Cl. H04N 21/482

(52) U.S. Cl. 725/56

(57) ABSTRACT

In embodiments of tuner control for streaming live television, a client device can be implemented to utilize the HTTP protocol and REST APIs to communicate with the media streamer to query a list of television channels and initiate tuning to a channel of streaming video content to be decrypted, transcoded, encrypted, and streamed to the client device.

### RELATED APPLICATIONS

This application claims priority to U.S. Provisional Application Ser. No. 61/429,914 filed Jan. 5, 2011, entitled “Controlling Cable and Satellite Tuners for Streaming Live TV within the Home,” the disclosure of which is incorporated by reference herein in its entirety.

### BACKGROUND

The traditional notion of watching television at home has evolved into many different forms of viewing television content, on many different devices. For example, users can watch television content, such as live television, recorded television, and time-shifted programs and movies, on various devices, such as televisions, display devices, entertainment devices, computers, and even mobile devices, such as tablets and mobile phones. However, television content that is viewed on a mobile device, such as a tablet or mobile phone, is primarily content that is either stored on the device or already recorded content that can be streamed to the device without interruption. There are challenges to streaming live television for viewing on a client device, such as when a user wants to change channels. Conventional television devices rely on a hardware remote control device to control channel changes. However, a remote control device is only useful to a user when used directly in front of a television device, such as to change a channel on a television or set-top box client device in the same room that a user is watching television. For television content that is viewed on a mobile device, such as a tablet or mobile phone, anywhere throughout a home or similar environment, there is not a standard mechanism to control the tuner of a set-top box client device, such as when the client device is located in another room of a house from where the user is watching television on a mobile device.

### BRIEF DESCRIPTION OF THE DRAWINGS

Embodiments of tuner control for streaming live television are described with reference to the following Figures. The same numbers may be used throughout to reference like features and components that are shown in the Figures:

FIG. 1 illustrates an example system in which embodiments of tuner control for streaming live television can be implemented.

FIG. 2 illustrates an example software stack for a media streamer that implements embodiments of tuner control for streaming live television.

FIG. 3 illustrates example method(s) of tuner control for streaming live television in accordance with one or more embodiments.

FIG. 4 illustrates various components of an example electronic device that can implement embodiments of tuner control for streaming live television.

### SUMMARY OF THE INVENTION

One embodiment includes a method comprising requesting, by an end user device, the list of programming in the form of channel map, receiving in the end user device, the list of channel numbers and associated data, sending a tune command, using HTTP, to a gateway device, indicating the channel selection made by a user of the end device, and causing the channel to change, receiving a URI to a tuned output stream, and controlling the tuner to tune to the requested channel number. In one embodiment, the request for the list of channels can be made via an HTTP client of the requestor. In one embodiment, the end user device can communicate with the headless gateway device. In one embodiment, the end user device is located out of direct line of sight with the gateway device. In one embodiment, multiple client devices can request channel changes from the gateway device. In one embodiment, the end user device is not connected via IR or cable with the gateway device. In one embodiment, the device additionally receives the tuner used for tuning to the channel and the channel number tuned.

Another embodiment, includes an end user streaming video consumption device comprising a memory for storing channel guide information, a processor configured to execute instructions to receive guide content, send a tune command, using HTTP, indicating the channel selection made by a user of the end device; and receive a URI to a tuned output stream. In one embodiment, the end user device is communicating with a headless gateway device. The one embodiment, the end user device is located out of direct line of sight with the gateway device. In one embodiment, the processor is additionally configured to receive a tuner used for tuning to the channel and the channel number tuned.

One embodiment includes a method for controlling the tuner on a gateway device comprising receiving a tune command, using HTTP, indicating the channel selection made by a user of an end device, translating the channel number to the parameters needed to control the tuner, controlling the tuner to cause the channel to change, and sending a URI to a tuned output stream. In one embodiment, multiple client devices can request channel changes for their respective devices. In one embodiment, the gateway is a headless. In one embodiment, the gateway is located out of direct line of sight with the end user device. In one embodiment, the method additionally comprising the tuner used for tuning to the channel and the channel number tuned.

### DETAILED DESCRIPTION

In embodiments, tuner control for streaming live television can be implemented for a better user experience when changing television channels on a client device, such as for streaming live television from a media streamer to the client device via a router in a home or business environment. In implementations, live television can be streamed to a client device utilizing hypertext transfer protocol (“HTTP”) Live Streaming (HLS) or other techniques that may be implemented to stream live television and other video content over HTTP. For example, Dynamic Adaptive Streaming over HTTP (DASH) may be utilized for streaming content to a client device, and embodiments of tuner control for streaming live television can be implemented accordingly.

References to a gateway device refer to any transcoding device. In one embodiment, the gateway device connects directly to the coax, or other delivery medium, and thus includes tuner(s) or other content selection functions. In yet other embodiments, the gateway device may use and control a tuner in a set top box or DVR. For example, the gateway device can talk to a set top box where a tuner actually resides. The use of one term over the other is not intended to be limiting.

While features and concepts of tuner control for streaming live television can be implemented in any number of different devices, systems, networks, and/or configurations, embodiments of tuner control for streaming live television are described in the context of the following example devices, systems, and methods.

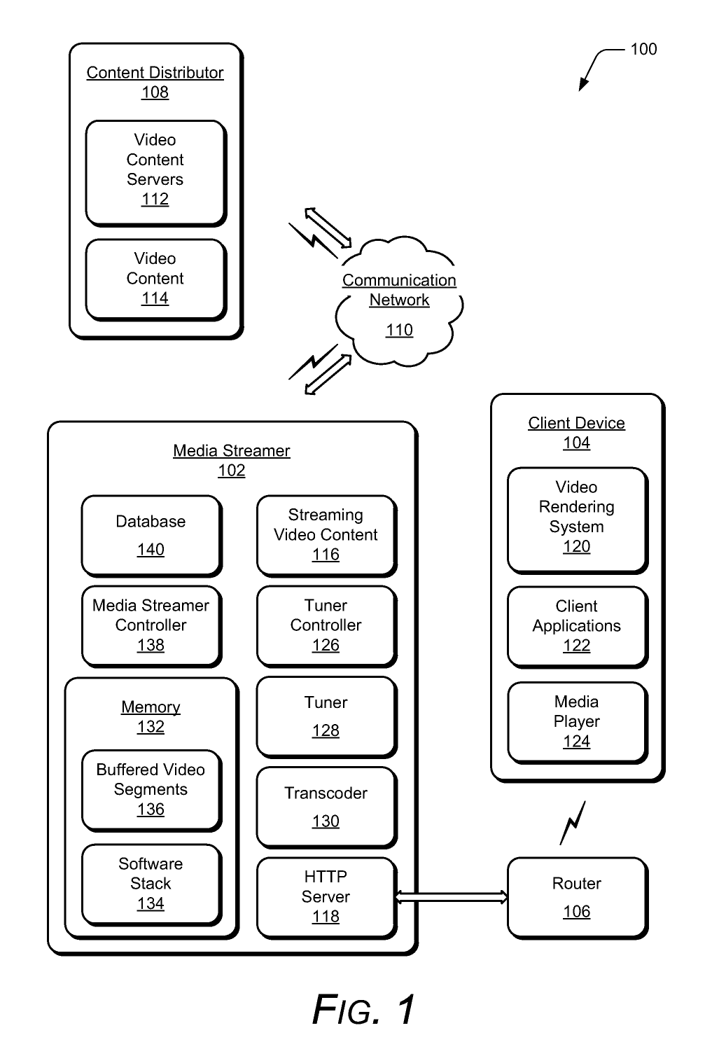

FIG. 1 illustrates an example system 100 in which embodiments of tuner control for streaming live television can be implemented. The example system 100 includes a media streamer 102 that is implemented to communicate streaming video content to a client device 104 via a router 106, such as in a home or business environment. The media streamer device can be a headless device, that is a device without infrared or a front panel for the end device to use for communicating channel changes. A headless device can also be a device that has no hardwired or video output to the TV or STB. In the embodiments described herein, the client device can change the channel on the headless STB (or media streamer device) from anywhere in the home or other defined location using HTTP. The example system also includes a content distributor 108 and/or other video content sources that deliver video content and data to any number of various devices via a communication network 110.

Any of the services and devices can communicate via the communication network 110, which can be implemented to include a wired and/or a wireless network. The communication network can also be implemented using any type of network topology and/or communication protocol, and can be represented or otherwise implemented as a combination of two or more networks, to include IP-based networks and/or the Internet. The communication network may also include mobile operator networks that are managed by a mobile network operator and/or other network operators, such as a communication service provider, cell-phone provider, and/or Internet service provider.

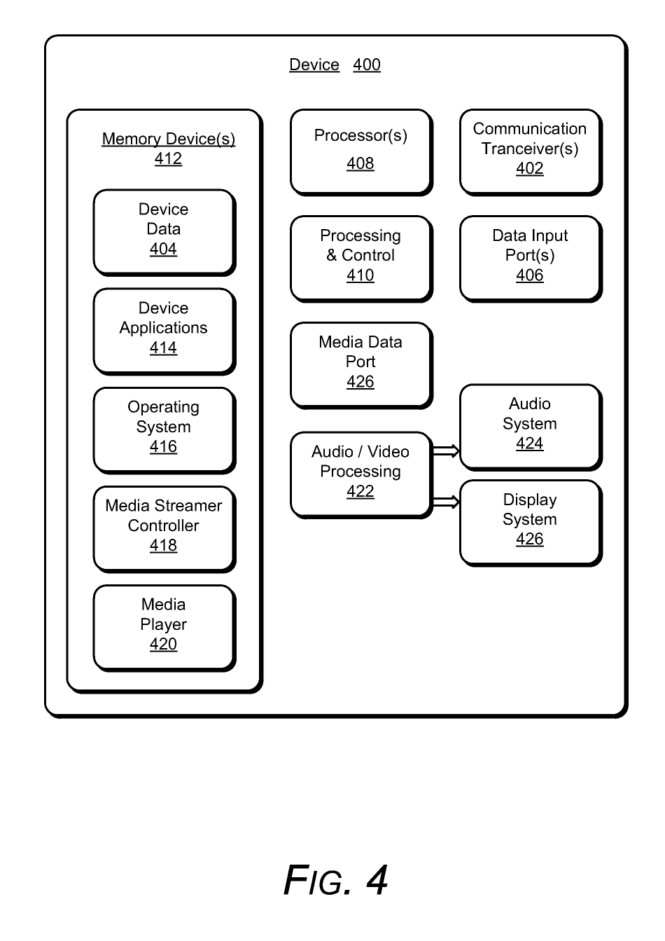

The content distributor 108 includes video content servers 112 to distribute video content 114 to the media streamer 102, such as streaming live television that is distributed via a coaxial cable system. The streaming video content can include any type of audio, video, and/or image data in the form of television programming, movies, on-demand video, interactive games, advertisements, and the like. The content distributor can be implemented with various components, such as a processor and memory devices, as well as with any combination of differing components as further described with reference to the example electronic device shown in FIG. 4. For example, the content distributor includes storage media, such as any type of memory and/or suitable electronic data storage, to store or otherwise maintain the video content and other data.

The media streamer 102 receives the streaming video content 116 from the content distributor 108, and an HTTP server 118 is implemented to communicate the streaming video content, such as live television, to the client device 104 via the router 106. The client device may be implemented as any one or combination of a communication, computer, media playback, gaming, entertainment, and/or electronic device, such as a PC, mobile phone or tablet device, which can be configured as a television client device to receive and playback video content. The client device can be implemented with various components, such as a processor and memory devices, as well as with any combination of differing components as further described with reference to the example electronic device shown in FIG. 4.

For example, the client device 104 includes a video rendering system 120 to playback video content for viewing on an integrated display device. The client device also includes various client applications 122 that are implemented to manage the video content playback and communication with the media streamer via the router. For example, the client device can include a media player 124 that is implemented to manage media content playback. Additionally, the client device can be implemented to utilize the HTTP protocol (using an internal HTTP client) and REST application programming interfaces (“APIs”) to communicate with the media streamer to query a list of television channels and initiate tuning to a channel of streaming video content to be decrypted, transcoded, encrypted, and streamed to the client device.

As a device, the media streamer 102 can be implemented with various components, such as a processor and memory devices, as well as with any combination of differing components as further described with reference to the example electronic device shown in FIG. 4. In this example, the media streamer includes a tuner controller 126, a tuner 128, and a transcoder 130. The tuner controller can receive an input from the client device 104 to switch from a first video content stream to a second video content stream, such as when a user is watching a television program on the client device and then initiates a channel change. The tuner tunes to the television channel frequency that correlates to the channel change input, and the transcoder then decrypts and transcodes the streaming video content 116. The transcoder may also be implemented with a cryptography module (MCard) to decrypt and/or transcrypt the streaming video content.

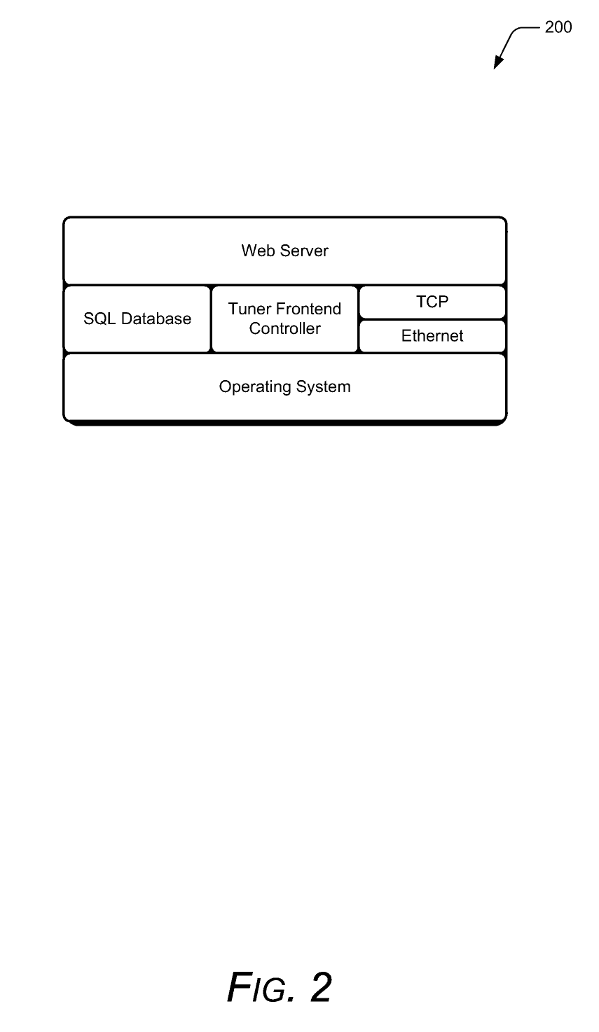

The media streamer 102 includes memory 132 that maintains a software stack 134, and can be implemented as a memory buffer for buffered video segments 136 of the streaming video content 116. An example of the software stack is described with reference to FIG. 2. The media streamer 102 also includes a media streamer controller 138 that can be implemented as computer-executable instructions, such as a software application, and executed by one or more processors to implement the various embodiments described herein. The media streamer controller (also referred to as a device controller) implements optimizations for live television playback when a television channel change input is received.

When a channel change input is received from the client device 104, the tuner 128 at the media streamer is tuned, and the transport for the selected television program is acquired, decrypted, transcoded, segmented, and encrypted for streaming to the client device. The process can be implemented using the HTTP Live Streaming protocol (or any other protocol for streaming video to end devices such as DASH), in which case the video segments are listed in a content manifest file in the order of playback at the client device. The information for content manifest files are maintained in a database 140, such as a SQL database, to track which television channels are tuned and the data that corresponds to a tuned television channel.

Before playback of the video content begins at the client device after a channel change has been initiated, a minimum number of the buffered video segments 136 are typically buffered at the media streamer, and identified in the content manifest file that correlates to the streaming video content. The transcoder writes the video segments into the memory buffer, and a video segment is multiple frames of the video content. For example, a one-second video segment may include thirty frames, and a client device may be designed to wait for ten seconds of the buffered video segments before the video content is downloaded to the client device. For HTTP Live Streaming (and other streaming protocols such as DASH), a common implementation is ten-second segments with approximately ten of the buffered video segments listed in the content manifest file. This content buffering latency varies with different devices and manufacturers.

Standard protocols such as HTTP protocol for message transport (http://www.w3.org/Protocols/rfc2616/rfc2616.html), XML as the message format (http://www.w3.org/TR/REC-xml) can be used. In such implementations, the standard software architecture of Representational State Transfer (http://en.wikipedia.org/wiki/Representational_State_Transfer) is used to communicate between the media streamer and the end device. However, these basic protocols and building blocks fail to provide a specific way to control a STB for live streaming of content to a device.

Therefore, a protocol for controlling television, cable and satellite tuners over HTTP using a URL scheme (REST) and utilizing XML as the format for providing results back to the caller is needed and is described herein.

As illustrated in FIG. 1, the live television media streamer consists of a tuner frontend, demodulator, cryptography module, transcoder and an ethernet interface. The live television tuner using in-band or out-of-band schemes obtains the channel lineup for the list of channels viewable on the tuner. This disclosure describes how the end device (portable media player, tablet or personal computer) can query the tuner for the list of channels and tune it so that the content can be decrypted, transcoded, encrypted and streamed to the end device.

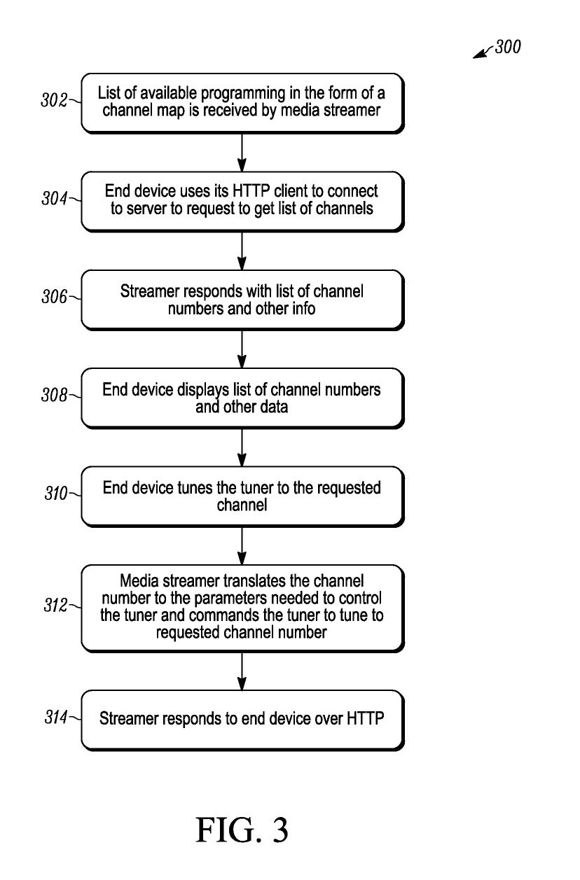

FIG. 3 illustrates a software stack associated with the streaming server. The software stack may include a webserver, a SQL DB application, a front end controller, a TCP stack and an Ethernet controller, and an operating system, such as LINUX.

The sequence of protocol interactions that occur between the end device and the streamer are described below:

The streamer runs an HTTP server and exports REST APIs to query for a channel list and tuner control.

Channel map API:
a. Using either in-band or out-of-band frequency, the streamer receives a standard channel map and translates each channel number to tuner frequency and MPEG program number.
b. The end device uses the REST API over HTTP to get the list of channels.
c. The streamer responds over HTTP with the list of channel numbers as XML data.

The above mentioned API for getting the channel map is one embodiment in which the end device communicates or talks to the streamer to get this information.

Another embodiment employs the end device to query a server over the Internet and download the channel map and associated data and process them internally. Using either of the steps above, the end device can get a list of channel numbers and associated data. Using this information, it can proceed to the next step of tuning the streamer to that channel.

Tune channel API:
a. The end device uses the REST API over HTTP to tune the tuner to the channel requested by the user on the end device. The parameter to the API consists of a channel number and optionally an output format/type for the live stream that the end device can natively display.
b. The media streamer uses the internal table to translate the channel number to the parameters needed to control the tuner and commands the tuner to tune to that channel number.
c. The media streamer responds to the end device over HTTP using XML. If the tune succeeds, then the response consists of a uniform resource identifier (“URI”) to the output stream, optionally the tuner in use, and optionally the channel number tuned. If the tune request fails, then the response consists of error codes. If another tune command is sent before the tuner completed the previous command, an error code is sent to indicate that the previous command was aborted.

This embodiment enables remote control of a tuner without external hardware (such as a remote control or an IR-blaster). Standard technologies and protocols over Ethernet can be used to accomplish this. For example, the HTTP protocol can be used by the client device to connect to the media streamer over WiFi using the home router. Once the client device connects to the media streamer using the HTTP protocol, commands can be sent to it using REST APIs. This embodiment allows the user of the end device to be anywhere in the home and control the live media stream. The embodiment also enables a standard approach to find the list of channels, an XML output and the associated schema and a set of error codes to notify the user about the outcome of the request.

The Motorola Media Streamer may use this protocol to provide optimal channel viewing experience for live television being streamed to the end device (portable media player, tablet or personal computer). The protocol allows the client device to obtain the list of channels from the media streamer and provide the channel lineup to the user and allows them to control the live television stream that is being sent to their device. In other embodiments, the channel list can be obtained from a network guide server.

### Media Streamer Control Protocol

The Media streamer control lets the client applications learn the potential impacts of channel changes, to command a channel change, and to get the channel mappings using the HTTP protocol to connect to it and send requests and obtain responses

The details of the REST APIs, including the parameters, the return values, the XML result and associated schemas are described in more detail below:

### Tune Channel

The following URI returns the playlist URL of the target channel for the mode of interest.

TABLE 1
Sample REST API request and response of command to tune to a channel

| | |
|---|---|
| URI | http://{streaming-server}/tuner/tunechannel?c= |
| | <channel-ID>&m=<mode> |
| METHODS | GET |
| PARAMETERS | 1. The ID of the target channel. |
| | 2. The mode, i.e. the type of the device |
| RETURN VALUES | 200 OK, 404 (No Signal), 405 (Not Authorized), |
| | 406 (No Such Channel) |

```
GET http://{streaming-server}/tuner/tunechannel?c=704&m=type1
RETURNS
<?xml version=″1.0″ encoding=″UTF-8″?>
<streamerContent>
  <channel number=”704” name”NBC”>
  <tunerID>2</tunerID>
  <playlist-url>http://streamer.local/tuner/manifest/704.m3u8</playlist-url>
  <sourceID>2984</sourceID>
  </channel>
</streamerContent>
```

### Channel List

This URI returns the channel map of the media streamer device, allowing the end device to display the list of available television channels to the user.

TABLE 2
Sample REST API request and response of command for
getting the channel map from the tuner

| | |
|---|---|
| URI | http://{streaming-server}/tuner/channellist |
| METHODS | GET |
| RETURN VALUES | 200 OK, 404 (Not Found) |

```
GET http://{streaming-server}/tuner/channellist
RETURNS: (protected metadata of the Mover status update)
<?xml version=″1.0″ encoding=″UTF-8″?>
<channelList>
  <sequenceNumber>101</sequenceNumber>
  <channel number=”704” name”NBC”/>
  <channel number=″705″ name=″ABC″/>
  <channel number=″706″ name=″CBS″/>
</channelList>
```

The following tables describe the schemas of the XML data contained in the response to the REST APIs sent to the media streamer.

TABLE 3
XML schema for the response to the tune channel command
XML Schemas
Tune Channel

```
<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″
elementFormDefault=″qualified″>
  <xs:element name=”streamerContent”>
  <xs:element name=″channel″>
  <xs:complexType>
    <xs:attribute name=″number″ type=″xs:string″ use=″required″/>
    <xs:attribute name=″name″ type=″xs:string″/>
    <xs:element name=”tunerID” type=”xs:string”/>
    <xs:element name=″playlist-url″ type=″xs:string″/>
  </xs:complexType>
  </xs:element>
</xs:element>
</xs:schema>
```

TABLE 4
XML schema for the response to the command to get the channel map
Channel List

```
<?xml version=″1.0″ encoding=″utf-8″?>
<xs:schema xmlns:xs=″http://www.w3.org/2001/XMLSchema″
xmlns:wmh=″http://www.wmhelp.com/2003/eGenerator″
elementFormDefault=″qualified″>
  <xs:element name=”channelList”>
  <xs:element name=″sequenceNumber″/>
  <xs:complextype>
    <xs:sequence>
    <xs:element name=″channel″>
    <xs:complexType>
      <xs:attribute name=″number″ type=″xs:string″ use=″required″/>
      <xs:attribute name=″name″ type=″xs:string″/>
    </xs:complexType>
    </xs:element>
  </xs:sequence>
  </xs:complexType>
</xs:element>
</xs:schema>
```

FIG. 2 illustrates an example of the software stack 134 shown in FIG. 1, and implemented in the media streamer 102. In this example, the software stack includes a Web server, an implementation of the SQL database application (e.g., the database 140 shown in FIG. 1), an implementation of the tuner controller 126 (also referred to as a tuner frontend controller), provisions for TCP and Ethernet communication, and an operating system interface, such as LINUX.

Example method 300 is described with reference to FIG. 3 in accordance with one or more embodiments of tuner control for streaming live television. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of tuner control for streaming live television. The order in which the method blocks are described are not intended to be construed as a limitation, and any number or combination of the described method blocks can be combined in any order to implement a method, or an alternate method.

At block 302, the list of available programming in the form of a channel map is received by the media streamer either in-band or out-of-band frequency. The channel map contains information that has the relationship between a channel number and the tuner frequency on which the program is available, and the MPEG program number in the set of available programs on that frequency.

At block 304, the end device uses its HTTP client to connect to the HTTP server (also referred to as the web server) executing on the media streamer to make a request to get a list of the channels using the REST API as shown in the example Table 2.

At block 306, the steamer responds to the REST API over HTTP with the list of channel numbers as XML data. This XML data contains a list of channel numbers that can be viewed by the client, data, and other metadata that can be displayed to the user such as the channel name.

At block 308, end device receives and displays a list of channel numbers and associated data that was parsed from the XML data received from block 306.

At block 310, end device uses the REST API over HTTP to tune the tuner to the channel requested by the user on the end device. The parameter to API consists of the channel number and optionally an output format/type for the live stream that the end device can natively display. This allows different types of clients to make the channel change request and have the media streamer generate streams that are customized for the format supported by the end device requesting it.

At block 312, the media streamer uses the internal table (built using the channel map that was received either in-band or out-of-band) to translate the channel number to the parameters needed to control the tuner and commands the tuner to tune to that channel number.

At block 314, the streamer responds to the end device REST API over HTTP using XML data. If the tune succeeds, then the response consists of a URI to the output stream, the tuner that was used for tuning to the channel (optional) and the channel number was tuned to (optional). If the tune fails, then the response consists of error codes. If another tune command is sent before the tuner completed the previous command, an error code is sent to indicate that the previous command was aborted.

FIG. 4 illustrates various components of an example electronic device 400 that can be implemented as any device described with reference to any of the previous FIGS. 1-3. In embodiments, the electronic device may be implemented as a media streamer 102, a client device 104, or the content distributor 108, such as described with reference to FIG. 1. Alternatively or in addition, the electronic device may be implemented in any form of device that can receive and playback streaming video content, such as any one or combination of a communication, computer, media playback, gaming, entertainment, mobile phone, and/or tablet computing device.

The electronic device 400 includes communication transceivers 402 that enable wired and/or wireless communication of device data 404, such as received data, data that is being received, data scheduled for broadcast, data packets of the data, etc. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers.

The electronic device 400 may also include one or more data input ports 406 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones or cameras.

The electronic device 400 includes one or more processors 408 (e.g., any of microprocessors, controllers, and the like), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 410. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 400 also includes one or more memory devices 412 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 400 may also include a mass storage media device.

A memory device 412 provides data storage mechanisms to store the device data 404, other types of information and/or data, and various device applications 414 (e.g., software applications). For example, an operating system 416 can be maintained as software instructions within a memory device and executed on the processors 408. The device applications may also include a device manager, such as any form of a control application, software application, signal-processing and control module, code that is native to a particular device, a hardware abstraction layer for a particular device, and so on. The electronic device may also include a media streamer controller 418 and a media player 420, such as for a media streamer device, to implement embodiments of tuner control for streaming live television.

The electronic device 400 also includes an audio and/or video processing system 422 that generates audio data for an audio system 424 and/or generates display data for a display system 426. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 428. In implementations, the audio system and/or the display system are external components to the electronic device. Alternatively, the audio system and/or the display system are integrated components of the example electronic device.

Although embodiments of tuner control for streaming live television have been described in language specific to features and/or methods, the subject of the appended claims is not necessarily limited to the specific features or methods described. Rather, the specific features and methods are disclosed as example implementations of tuner control for streaming live television.

We claim:

1. A method comprising:
requesting, by an end user device, the list of programming in the form of channel map;
receiving in the end user device, the list of channel numbers and associated data;
sending a tune command, using HTTP, to a gateway device, indicating the channel selection made by a user of the end device and causing the channel to change; and
receiving a URI to a tuned output stream.

2. The method as recited in claim 1, wherein the request for the list of channels is made via an HTTP client of the requestor.

3. The method as recited in claim 1, wherein the end user device is communicating with a headless gateway device.

4. The method as recited in claim 1, wherein the end user device is located out of direct line of sight with the gateway device.

5. The method as recited in claim 1, wherein multiple client devices can request channel changes from the gateway device.

6. The method as recited in claim 1, wherein the end user device is not connected via IR or cable with the gateway device.

7. The method as recited in claim 1, additionally receiving an identifier for the tuner used for tuning to the channel and the channel number tuned.

8. An end user streaming video consumption device comprising:
a memory for storing channel guide information;
a processor configured to:
execute instructions to receive guide content;
send a tune command, using HTTP, indicating the channel selection made by a user of the end device; and
receive a URI to a tuned output stream.

9. The device as recited in claim 8, wherein the end user device is communicating with a headless gateway device.

10. The device as recited in claim 8, wherein the end user device is located out of direct line of sight with the gateway device.

11. The device as recited in claim 8, wherein the processor is additionally configured to receive an identifier for the tuner used for tuning to the channel and the channel number tuned.

12. A method for controlling the tuner on a gateway device comprising:
receiving a tune command, using HTTP, indicating the channel selection made by a user of an end device;
translating the channel number to the parameters needed to control the tuner;
controlling the tuner to cause the channel to change; and
sending a URI to a tuned output stream.

13. The method as recited in claim 12, wherein channel changes can be received from multiple end user devices.

14. The method as recited in claim 12, wherein the gateway is headless.

15. The method as recited in claim 12, wherein the gateway is located out of direct line of sight with the end user device.

16. The method as recited in claim 12, additionally comprising sending an identifier for the tuner used for tuning to the channel and the channel number tuned.
